(19) United States
(12) Patent Application Publication
(10) Pub. No.: US 2012/0296662 A1
(43) Pub. Date: Nov. 22, 2012

(54) HEALTHCARE AND WELLNESS WEB PLATFORM

(76) Inventor: Lauren G. Bailey, St. Simons Island, GA (US)

(21) Appl. No.: 13/475,825

(22) Filed: May 18, 2012

Related U.S. Application Data
(60) Provisional application No. 61/487,475, filed on May 18, 2011.

(51) Int. Cl. G06Q 50/22

(52) U.S. Cl. 705/2

(57) ABSTRACT

A method for a healthcare and wellness web platform includes storing a health information document of a user on a web platform in response to a health information request. The stored health information document is controllable by the user. The method includes representing a plurality of healthcare providers as members of a healthcare team on the web platform. The healthcare team may be specific to the user. The method includes granting access to the health information document to the plurality of members of the healthcare team according to configurable criteria.

### FIELD

The subject matter disclosed herein relates to healthcare and wellness and more particularly relates to a healthcare and wellness web platform.

### BACKGROUND

### Description of the Related Art

Much time is spent in storing and managing a patient's health records, transferring them to other healthcare providers, and the like. Often, patients have little to no control over their own health records. Moreover, even when health records are transferred to a new healthcare provider, the new healthcare provider often does not confer with a patient's other healthcare providers regarding the patient's health.

Furthermore, the healthcare industry often focuses on treating diseases once they have manifested themselves, rather than preventing the diseases in the first place. By addressing wellness and disease prevention, including instructing individuals on healthy living, healthcare costs may be reduced and money saved by not having to fight preventable diseases.

### BRIEF SUMMARY

A method is provided for a healthcare and wellness web platform. In one embodiment, the method includes storing a health information document of a user on a web platform in response to a health information request. The stored health information document may be controllable by the user. In one embodiment, the method includes representing a plurality of healthcare providers as members of a healthcare team on the web platform. The healthcare team may be specific to the user. In one embodiment, the method includes granting access to the health information document to the plurality of members of the healthcare team according to configurable criteria.

In one embodiment, the method includes displaying content from a content provider. The content provider includes a wellness and prevention entity. The content provider may be different from the plurality of healthcare providers. In a further embodiment, the method includes managing the content from the content provider. Managing content may include receiving commands from the content provider to store, delete, and/or edit the content for one or more users. In a further embodiment, the method includes storing, deleting, and/or editing the content in response to receiving the commands. In one embodiment, the content includes wellness and/or prevention content. In one embodiment, the content includes customized content or static content. The customized content includes a menu, a health goal, a shopping list, an education plan, an activity plan, and/or an exercise plan. The static content includes a health guide, an educational video, and/or a health lesson. In one embodiment, the wellness and prevention entity is a dietician.

In one embodiment, the method includes providing a plurality of user categories of users on the web platform. The user categories include a patient user category, a healthcare provider user category, and a content provider user category. The user may be a patient user and the healthcare providers each may be healthcare provider users. In one embodiment, the user categories further include a representative user category and the method further includes communicating the health information request from the user to a representative user instructing the representative user to obtain the health information document.

In one embodiment, the method includes providing a virtual appointment between the user and a content provider and/or a particular healthcare team member. In one embodiment, the method includes providing the user with a user account on the web platform. The user account may be associated with a plurality of applications on the web platform, the user account based on a user category of the user. In one embodiment, one or more of the applications are configurable by the user and the method further includes adding a first application to the user account in response to a user selection of the first application and removing a second application from the user account in response to a user removal of the second application.

In one embodiment, the method includes storing additional health information from the user. The additional health information may include health goals, a health status, calendar information, and/or medication information. In one embodiment, at least two of the plurality of members are associated with different healthcare sources, different healthcare professions, and/or different healthcare fields. In one embodiment, the method further includes generating a lesson recommendation for the user. The lesson recommendation may recommend one or more health lessons for participation by the user over the web platform.

An apparatus is provided for a healthcare and wellness web platform. The apparatus includes modules that, in at least a portion of the described embodiments, include a health information module, a healthcare team module, and an access module.

In one embodiment, the health information module stores a health information document of a user on a web platform in response to a health information request. The stored health information document may be controllable by the user. In one embodiment, the healthcare team module represents a plurality of healthcare providers as members of a healthcare team on the web platform. The healthcare team may be specific to the user. In one embodiment, the access module grants access to the health information document to the plurality of members of the healthcare team according to user configurable criteria.

In one embodiment, the apparatus further includes a content provider module displaying content from a content provider. The content provider may be a wellness and prevention entity. The content provider may be different from the plurality of healthcare providers. In a further embodiment, the content provider module manages content from a content provider. In a further embodiment the content provider module managing content further includes the content provider module receiving commands from the content provider to store, delete, and/or edit the content for one or more users. In one embodiment, the content provider module stores, deletes, and/or edits the content in response to receiving the commands. In one embodiment, the content includes wellness and/or prevention content. In one embodiment, the content is customized or static content. The customized content includes a menu, a health goal, a shopping list, an education plan, an activity plan, and/or an exercise plan. The static content includes a health guide, an educational video, and/or a health lesson. In one embodiment, the wellness and prevention entity is a dietician.

A computer program product including a storage device storing machine readable code executed by a processor to perform operations is also presented. In one embodiment, the operations include storing a health information document of a patient on a web platform in response to a health information request. The stored health information document may be controllable by the patient. In one embodiment, the operations include representing a plurality of healthcare providers as members of a healthcare team on the web platform. The healthcare team may be specific to the patient. In one embodiment, the operations include granting access to the health information document to the plurality of members of the healthcare team according to configurable criteria.

In a further embodiment, the operations include displaying content from a content provider. The content provider, in one embodiment, is a wellness and prevention entity. The content provider may be different from the plurality of healthcare providers.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is a schematic block diagram illustrating one embodiment of a system for a healthcare and wellness platform in accordance with the present subject matter;

FIG. 2 is a schematic block diagram illustrating another embodiment of a system for a healthcare and wellness platform in accordance with the present subject matter;

FIG. 3 is a schematic block diagram illustrating one embodiment of an apparatus for a healthcare and wellness platform in accordance with the present subject matter;

FIG. 3 is a schematic block diagram illustrating one embodiment of an apparatus for a healthcare and wellness platform in accordance with the present subject matter;

FIG. 4 is a schematic block diagram illustrating another embodiment of an apparatus for a healthcare and wellness platform in accordance with the present subject matter;

FIG. 5 illustrates one embodiment of a patient user page in accordance with the present subject matter;

FIG. 6 illustrates one embodiment of a healthcare provider user page in accordance with the present subject matter;

FIG. 7 illustrates another embodiment of a healthcare provider user page in accordance with the present subject matter;

FIG. 8A is a schematic flow chart diagram illustrating one embodiment of a method for a healthcare and wellness platform in accordance with the present subject matter;

FIG. 8B is a schematic flow chart diagram illustrating another embodiment of a method for a healthcare and wellness platform in accordance with the present subject matter; and

FIG. 9 is a detailed schematic flow chart diagram illustrating another embodiment of a method for a healthcare and wellness platform in accordance with the present subject matter.

### DETAILED DESCRIPTION

As will be appreciated by one skilled in the art, aspects of the present subject matter may be embodied as an apparatus, system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums and/or one or more storage devices.

Any combination of one or more computer readable medium may be utilized. The computer readable medium may be a computer readable signal medium or a computer readable storage medium. A computer readable storage medium maybe, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (“RAM”), a read-only memory (ROM), an erasable programmable read-only memory (“EPROM” or Flash memory), an optical fiber, a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Aspects of the present subject matter are described below with reference to schematic flowchart diagrams and/or schematic block diagrams of methods, apparatuses, systems, and computer program products according to embodiments of the subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

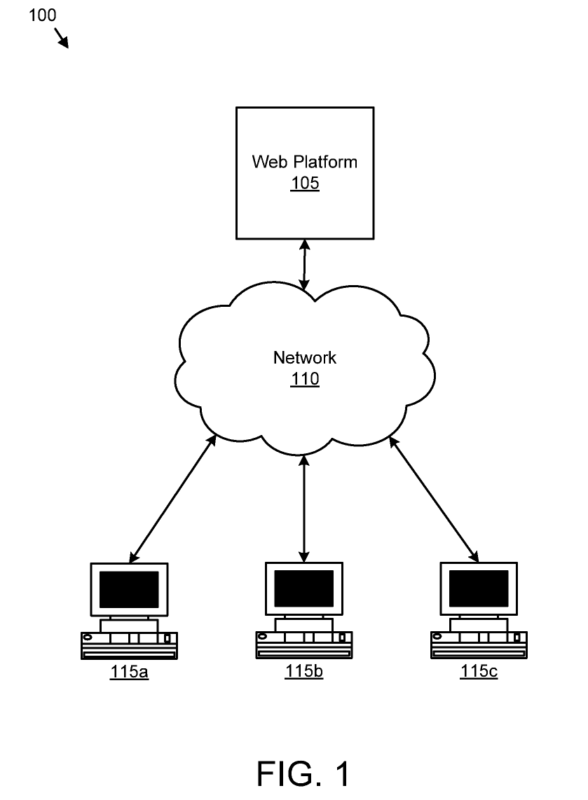

FIG. 1 illustrates one embodiment of a system 100 for a healthcare and wellness platform. The system 100 includes a web platform 105, a network 110, and a plurality of clients 115. The web platform 105 may host, store, include and/or provide web-based personal healthcare management and/or a web-based healthcare website for access over the network 110 by the plurality of clients 115. The web platform 105 may include and/or be implemented by servers, storage, databases and other infrastructure. One or more servers comprising the web platform 105 may be embodied as a computing device including a desktop computer, a portable computer, a server, a mainframe computer, and the like. The one or more servers may include memory storing computer readable programs and may include one or more processors that execute the computer readable programs as is well known to those skilled in the art. The computer readable programs may be tangibly stored in storage in communication with the one or more servers. The one or more servers may host, store, and/or provide the healthcare website for access, and/or download over the network 110 by the plurality of clients 115 as is known in the art.

The network 110 may comprise a global communications network such as the Internet, a Local Area Network (“LAN”), multiple LANs communicating over the internet, or any other similar communications network. Each client 115 may be embodied as a desktop computer, a portable computer, a server, a mainframe computer, a handheld computing device, a touch device, a personal desktop assistant (“PDA”), a tablet computer, an eBook reader, a mobile phone, a Smartphone, and the like.

Each client 115 may communicate with the web platform 105 through the network 110. In one embodiment, a client 115 communicates with the web platform 105 by way of an application, such as an Internet browser, executing on the client 115 and accesses and/or downloads web pages of the healthcare website as is known in the art. The healthcare website is described below.

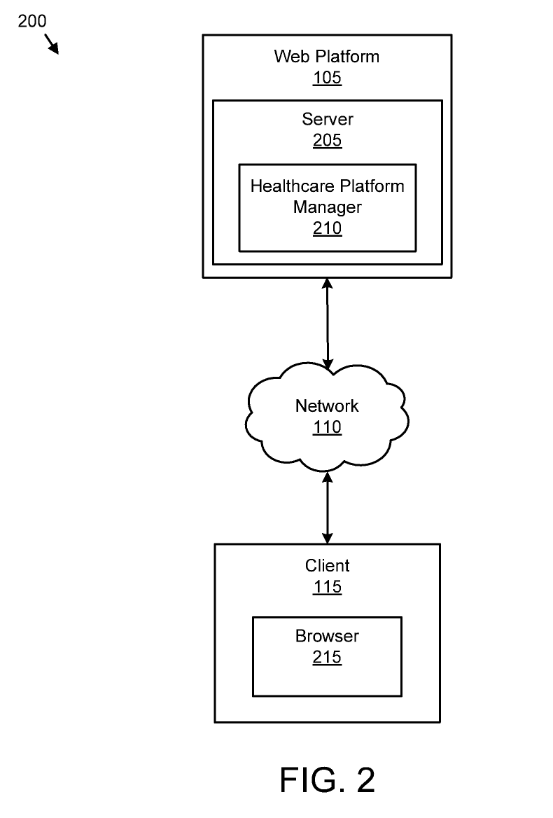

FIG. 2 illustrates another embodiment of a system 200 for a healthcare and wellness platform. The description of the system 200 refers to elements of FIG. 1, like numbers referring to like elements. The system 200 includes a web platform 105 that may be substantially similar to the web platform 105 depicted in FIG. 1.

The web platform 105 includes a server 205 with a healthcare platform manager 210. While the server 205, in the depicted embodiment, includes the healthcare platform manager 210, in certain embodiments, all or a portion of the healthcare platform manager 210 may reside and/or be embodied outside the server 205 and/or on multiple servers. The web platform 105 is in communication with a network 110 in communication with a client 115. The network 110 and the client 115 may be substantially similar to the like numbers elements in FIG. 1. Furthermore, the client 115 includes a browser 215. The browser 215 may be embodied as an application configured to present, access and/or download web pages as is known in the art.

The healthcare platform manager 210 may host, server, and/or include all or a portion of the healthcare website. The healthcare website may be embodied as one or more web pages available for access over the network 110. Each web page may include software code, images, and text as is known in the art. Specifically, each web page may include static and/or dynamic elements and include Hypertext Markup Language (“HTML”) code, JavaScript code, Flash animations, and the like.

The healthcare platform manager 210, in one embodiment, provides a patient with a platform to store the patient's health records. The patient may submit a request, through the healthcare platform manager 210, to a representative (e.g. an entity capable of retrieving health records), for a particular health record, and the representative may acquire the particular health record and upload it to the healthcare platform manager 210, saving the patient from having to acquire it personally. In addition, in one embodiment, the patient may upload the patient's own health records to the platform manager 210. Furthermore, the patient may also save additional health information on the healthcare platform manager 210, such as a medication list, a health blog, and the like. The patient may build a healthcare team that includes healthcare providers of various backgrounds. The patient may control the viewability of the patient's health records and other information among members of the healthcare team. In one embodiment, the patient may communicate with members of the patient's healthcare team or other content providers (e.g. regarding a particular health information document, for health questions, and the like).

In one embodiment, the healthcare platform manager 210 may accommodate various types of users such as patients, healthcare providers, and the like. In one embodiment, the healthcare platform manager 210 provides a plurality of user categories for the users on the web platform 105. Each user category may provide different privileges, roles, capabilities, and the like, and each user may be assigned a user category. The user categories may include a patient user category, a healthcare provider user category, a content provider user category, and the like. In one embodiment, a content provider user is able to upload content to the web platform 105 as described below. This content may be static content, persistent and viewable by more than one user. This content may also be customized content, such as a menu plan, specific to a particular user.

The content provider may be a health and wellness entity, such as a dietician, which provides patients with guidance on healthy living, disease prevention, and the like. Therefore, the healthcare platform manager 210 allows for healthcare providers, such as physicians, to view a patient's medical records and to communicate with each other regarding the patient to treat sickness and injury, and allow for a health and wellness content provider to provide the patient with content to help the patient avoid sickness and injury, thereby helping the patient implement and maintain a healthy lifestyle. The content provided by the content provider, in one embodiment, is more suited to the day-to-day living of the patient than the advice and/or treatment offered by the members of the healthcare team.

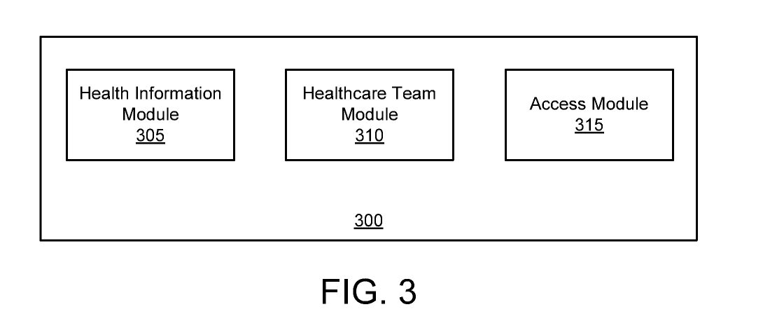

FIG. 3 illustrates one embodiment of an apparatus 300 for a healthcare and wellness platform. Specifically, the apparatus 300 may comprise one embodiment of the healthcare platform manager 210. The description of the apparatus 300 refers to elements of FIGS. 1-2, like numbers referring to like elements. The apparatus 300 includes one or more of a health information module 305, a healthcare team module 310, and an access module 315.

The health information module 305 stores health information documents of a user on the web platform 105. A health information document is a document, file, image, note, and/or the like for a user. The health information documents may include the user's health and/or medical records. In one embodiment, the health information documents include official health records from licensed healthcare providers. Examples of health information documents include, but are not limited to, a physician note, a procedure note, a medical history, a lab note, a medical image such as x-ray film, physical therapy notes, dietician notes, and the like. In one embodiment, the health information module 305 stores associated information with one or more of the health information documents such as physician information, date, condition treated, and the like. The database may store the health information documents as image files, text files, Portable Document Format (“PDF”) files, and/or any suitable file format. In one embodiment, the web platform 105 stores the health information documents using a database and/or any other suitable method. For example, the web platform 105 may store scanned copies of a patient's medical records in the database, an electronic file system, and/or the like.

Furthermore, in one embodiment, the stored health information documents are controllable by the user. Specifically, being controllable by the user means that a user may upload health information documents to the web platform 105, download health information documents from the web platform 105, delete health information documents, control access privileges to health information documents, view health information documents, add associated information to the health information documents, and/or the like.

In one embodiment, the health information module 305 receives health information requests. In one embodiment, the health information module 305 stores a health information document in response to a health information request. A health information request, as used herein, means a request to store a health information document on the web platform 105. In one embodiment, a user, such as a patient, submits a health information request. Specifically, the user, in one embodiment, may submit a health information request through the health information module 305 for a particular health information document. In one embodiment, the health information request includes a form that the user fills out—through the health information module 305—to request a health information document. For example, the health information module 305, through the web platform 105 (e.g. a webpage on the healthcare website) may provide the user with an electronic form. The form may include authorization to release medical information such as a Health Insurance Portability and Accountability Act (“HIPPA”) privacy authorization form. In one embodiment, the user specifies health information document identification information as part of the health information request. Health information document identification information, as used herein, is information that may identify a particular health information document and may include a physician, date of appointment, procedure, and the like.

In one embodiment, a user may upload the user's own health information document to the health information module 305. In one embodiment, a health information request is a request from a user to upload the user's own health information document. In one embodiment, the health information module 305 informs a user's representative to obtain and upload a health information document as is described below in response to receiving a health information request.

In one embodiment, the health information module 305 stores additional health information from the user. In a further embodiment, the additional health information includes health information authored by the user. The additional health information includes, but is not limited to a health log, health goals, a health status, a weight tracker, calendar information, and medication information. For example, a user may maintain a daily health log on how the user is feeling, any symptoms, and the like. The user may input the user's medications, appointments on the calendar, and the like. In certain embodiments, the user may add, edit, or delete information associated with each daily health log such as physician information, date, condition treated, and the like. The health status may include a set of questions that the user answers to evaluate a user's status at a particular moment in time based on the user's thoughts.

The healthcare team module 310 represents a plurality of healthcare providers as members of a healthcare team on the web platform 105. A healthcare team, as used herein, is an association of one or more healthcare providers for a particular user. The healthcare team may be specific to the user and each user may have an individual healthcare team. A healthcare provider may comprise a licensed healthcare professional and may include, but is not limited to, a physician, a physical therapist, a psychiatrist, a pharmacist, and other suitable health professionals. In one embodiment, healthcare providers may also include dieticians, physical therapists, personal trainers, and the like. In one embodiment, members of the healthcare team are healthcare providers focused on treatment of illness and/or injury. In some embodiments, members of the healthcare team are healthcare providers focused on health and wellness. In one embodiment, at least two of the healthcare team members are associated with different healthcare sources (e.g. different insurance companies, different hospitals, different physician offices, and the like), different healthcare professions, and/or different healthcare fields.

In one embodiment, each healthcare provider of a healthcare team is a user on the web platform 105. In a further embodiment, each healthcare team member has an account on the web platform 105, is classified as a healthcare provider on the web platform 105 (as described below), and the like. Furthermore, the user's healthcare team may comprise an association of one or more healthcare provider users (e.g. healthcare user accounts on the web platform 105) with the user's user account.

In one embodiment, the healthcare team module 310 receives a user selection of a particular healthcare provider for the healthcare team. A user selection, in one embodiment, is a request by a user to add a particular healthcare provider. For example, the healthcare team module 310 may detect and/or receive a user request to add a particular healthcare provider to the user's healthcare team. The user may locate a healthcare provider identifier on the web platform 105 (e.g. find the healthcare provider's name in a list of healthcare providers who have accounts on the web platform 105) and select the healthcare provider through the identifier, such as by clicking on the healthcare provider's name, to have the healthcare provider join the user's team and allow the healthcare provider to view the user's healthcare documents according to the user's criteria. Furthermore, in certain embodiments, a healthcare provider may request to be added to a user's healthcare team. In these embodiments, the user may receive the request and accept or deny the request. Furthermore, the healthcare team module 310 may represent the particular healthcare provider as the member of the healthcare team in response to receiving the user selection.

In one embodiment, if a healthcare provider does not have an account on the web platform 105, the user may send a request to the healthcare provider to join the web platform 105 and become a member of the user's healthcare team. The healthcare team module 310 may send an electronic message to the healthcare provider with instructions on how to join and create an account. In one embodiment, the healthcare team module 310 may grant a healthcare provider with temporary access and/or membership in a user's healthcare team.

In one embodiment, a healthcare team member is able to see names and/or identifiers of other healthcare team members of a user's healthcare team and is able to see that each is a member of the healthcare team for a particular user. Specifically, in one embodiment, the healthcare team module 310 displays identifiers (e.g. names, pictures, and the like) for the plurality of members and an association of the plurality of members with the healthcare team to a particular member of the healthcare team. Specifically, the identifiers and the association (showing that each is a member of a particular healthcare team) may be viewable by the user and each member of the healthcare team.

The access module 315 grants access to health information documents to the plurality of members of the healthcare team according to user configurable criteria. In one embodiment, each member of a particular user's healthcare team is able to view health information documents of the particular user. In some embodiments, the user is able to set individual permissions (e.g. through controls provided by web pages on the healthcare website) for certain healthcare team members, certain health information documents, and the like. For example, the user may set a particular health information document as “unviewable” to stop any health information team member from viewing the document. In one embodiment, the user may prevent a certain healthcare team member from seeing any or all health information documents. In one embodiment, the access module 315 prevents a healthcare provider from modifying or deleting health information documents of the user. The access module 315 may also control access to a user's additional health information as configured by the user.

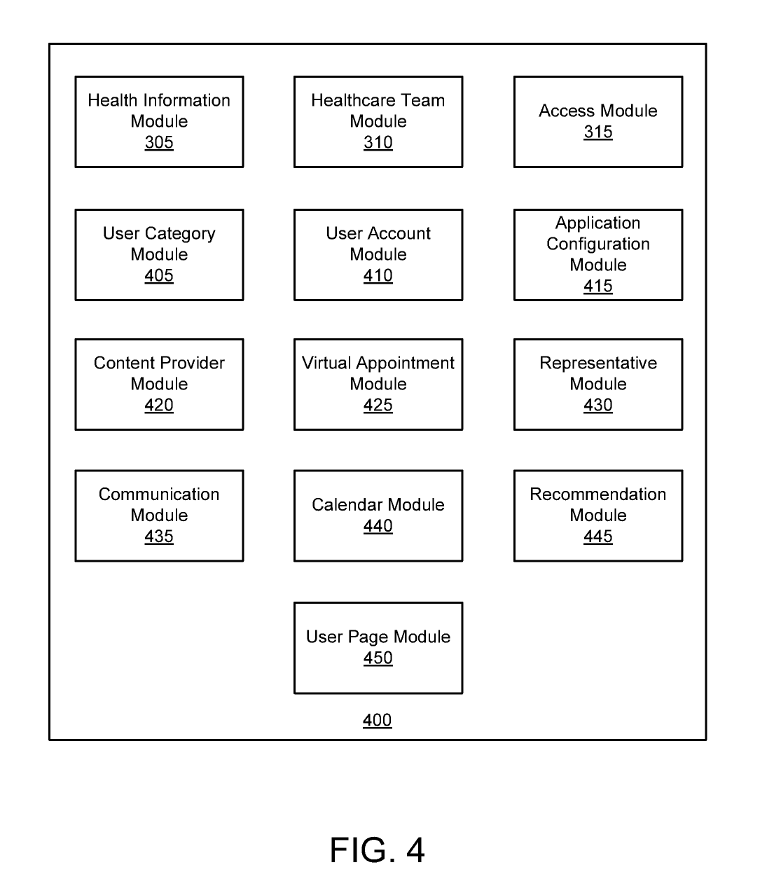

FIG. 4 illustrates another embodiment of an apparatus 400 for a healthcare and wellness platform. Specifically, the apparatus 400 may comprise one embodiment of the healthcare platform manager 210. The description of the apparatus 400 refers to elements of FIGS. 1-3, like numbers referring to like elements. The apparatus 400 includes the health information module 305, the healthcare team module 310, and the access module 315, which may be substantially similar to the like-named modules described above in relation to the apparatus 300 of FIG. 3. Furthermore, the apparatus 400 includes a user category module 405, a user account module 410, an application configuration module 415, a user page module 450, a content provider module 420, a virtual appointment module 425, a representative module 430, a communication module 435, a calendar module 355, a recommendation module 445, and a user page module 450.

The user category module 405 provides a plurality of user categories of users on the web platform 105. The user categories include, but are not limited to a patient user category, a healthcare provider user category, and a content provider user category. In one embodiment, a patient user is provided with the ability to create and manage a healthcare team as described above. Furthermore, in one embodiment, healthcare providers, such as those on healthcare teams of patient users, may be represented on the web platform 105 as healthcare provider users. A content provider user may add content for one or more users as is described below. In one embodiment, the user category module 405 further includes a representative user category as a user category. As described below, a representative user may obtain health information documents for a user.

The user account module 410 provides the user with a user account on the web platform 105. In one embodiment, the user account may be classified according to a user category of the user. The user account may grant the user with predetermined roles, responsibilities, access privileges, and/or the like depending on the user category associated with the user and/or user account for the user. For example, the user account module 410 may grant a patient user with the ability to create and manage a healthcare team. Likewise, the user account may grant a healthcare provider user with the ability to join a healthcare team, communicate with other healthcare providers, and the like. The user account may determine the look and functionality of a user interface for the user as described below.

A user's user account may be associated with a plurality of applications on the web platform 105. Each application may comprise an atomic and/or semi-atomic program configured to perform one or more specific functions. For example, all or a portion of the healthcare team module 305 and the health information module 310, described above, may comprise applications on the web platform 105. A user's user account may include multiple applications, each providing separate functionality. Applications may include, but are not limited to, a calendar application, a virtual check-up application, a shopping plan application, a menu plan application, a health goals application, and the like.

The application configuration module 415 configures a user's user account with various applications. In one embodiment, the application configuration module 415 configures a user's user account based on input from the user. Specifically, the application configuration module 415 may allow a user to add or remove applications to/from the user's user account. For example, in one embodiment, the application configuration module 415 adds a first application to the user account in response to a user selection of the first application and removes a second application from the user account in response to a user removal of the second application. In one embodiment, web pages of a user account, as described below, display a user's selected applications. The applications may be created, hosted, and/or maintained by the web platform 105 and/or an entity operating the web platform 105. In one embodiment, the application configuration 415 module stores, presents, and/or makes available various applications that a user may add to a user account.

In one embodiment, at least one application is a third-party application created and/or maintained by an entity distinct from the entity operating the web platform 105. For example, businesses, individuals, physicians' offices, public health organizations, and the like, may create and/or provide applications to provide various functions related to healthcare and wellbeing. For example, applications may track food stamps, vaccination availability, emergency response, safe traveling, and the like. In one embodiment, the application configuration module 415 provides an application storefront, through the web platform 105 and/or related websites, to offer applications for acquisition and/or purchase by a user.

In one embodiment, the application configuration module 415 does not allow a user to remove certain applications from the user account. In a further embodiment, these “core applications” include at least functionality, modules, and/or applications relating to the healthcare team, healthcare information document storage and access, patient user content (e.g. a patient's health blog, medication list, goal, and the like), health and wellness content (e.g. provided by a content provider through the content provider module 420 described below), and virtual appointments.

The content provider module 420 manages content from a content provider. A content provider may be a user on the system categorized as a content provider user as described above. Specifically, in some embodiments, the content provider is a wellness and prevention entity—an individual, group, business, and/or healthcare provider—focused on assisting individuals in maintaining healthy living, eating habits, weight loss, disease prevention, and the like. In one embodiment, a wellness and prevention entity comprises a dietician. In one embodiment, the content provider, which provides content for a particular user, is different from the plurality of healthcare providers on that particular user's healthcare team.

In one embodiment, managing content includes allowing the content provider to store, delete, and/or edit the content for one or more users. Specifically, in one embodiment, the content provider module manages content by receiving commands from the content provider to store, delete, and/or edit the content for one or more users. The content provider module, in one embodiment, stores, deletes, and/or edits the content in response to receiving the commands.

Content may include information on the web platform 105, available for one or more users, related to healthcare, wellness, disease prevention, and the like. Examples of content include videos, text, applications, Web-based Seminars (“webinars”), and the like. In one embodiment, content, as used herein, is distinct from a user's healthcare information documents described above, and is distinct from messages and communication from healthcare provider users of a user's healthcare team.

Furthermore, in one embodiment, the content includes wellness and/or prevention content, or information to help a user prevent disease and/or maintain a healthier lifestyle. In one embodiment, the content is static content or customized content. Customized content may be particular to an individual (e.g. a patient user) such as a menu, a health goal, a shopping list, an education plan, an activity plan, and an exercise plan. For example, a dietician may provide a user with a shopping list, based on the user's health history, to assist the user in purchasing and eating health foods. Static content may be applicable to a plurality of users and may include, but is not limited to, a health guide, an educational video, and a health lesson. For example, a content provider may upload a video on healthy eating that is accessible by multiple users.

In one embodiment, the content provider module 420 displays content from a content provider. For example, the content provider module 420 may display an exercise plan from a content provider to a user.

In one embodiment, the content provider has access to a user's health information documents. In certain embodiments, a user may grant a content provider access to the user's health information documents. Furthermore, in certain embodiments, a content provider has the ability to add, edit, and delete content from the web platform 105 and a health provider user is not able to load content onto the web platform 105. A content provider may be associated with a single patient user, multiple patient users, and the like. Furthermore, in one embodiment, a user is able to view content from multiple content providers.

The virtual appointment module 425 provides a virtual appointment between the user and the content provider (and/or a healthcare provider in some embodiments) through the web platform 105. A virtual appointment may include a text, video, and/or audio chat, through the web platform 105, between the user and the content provider. The virtual appointment module 425 may allow a user to hold a web conference with the content provider and/or healthcare provider, and may allow each party to view, access, add, and delete common documents.

The representative module 430 communicates a health information request from the user to a representative user instructing the representative user to obtain a specified health information document. A representative, in one embodiment, is a user that has the role, responsibility, and/or access privileges to upload health information documents for other users. The representative module 430 may communicate a health information request to the representative user to obtain the health information document. The representative user may obtain and upload the health information document for the user. Therefore, a user does not have to be concerned with tracking down and obtaining the user's own health information documents. Furthermore, if the representative user is a healthcare professional, the representative user may be able to obtain health information documents at a reduced price compared with a potential charge to a patient.

Certain healthcare organizations may charge for the release of healthcare information documents. Consequently, the representative module 430 may charge a user to retrieve these health information documents. The user may be charged through the user's user account, a credit card, a web-based payment system, and the like.

The communication module 435 communicates between users of the web platform with electronic messages such as e-mail, instant messages, text messages, messages associated with a user account, and the like. In one embodiment, the communication module 435 communicates from a first healthcare provider of a particular healthcare team to a second healthcare provider of the particular healthcare team through the web platform 105. Consequently, healthcare providers of a patient's healthcare team may communicate with one another about the patient. In one embodiment, the communication module 435 communicates a message between the user and a healthcare team member, a healthcare provider user, a content provider user and/or a representative user. In one embodiment, a user may communicate a message to one or more members of the user's healthcare team simultaneously.

In one embodiment, the communication module 435 communicates information to other electronic devices (e.g. portable electronic devices such as smartphones, laptops, and the like) in response to a user request. The user may also configure the communication module 435 to communicate such information on a regular basis (e.g. send a menu reminder every day at 1:00). Furthermore, the communication module 435 may communicate health information documents, additional health information of the user, and content from content providers.

The calendar module 355 maintains a calendar for the user. The calendar may track medications, goals, menus, appointments, and/or healthcare provider availability. A user may set reminders in the calendar to take certain medications, to eat certain foods, to attend virtual appointments, and the like. The calendar module 355 may interact with other applications and/or modules of the web platform in exchanging information such as medication information, menu information, and the like.

The recommendation module 445 generates a lesson recommendation for the user that recommends one or more health lessons for participation by the user over the web platform. In one embodiment, the recommendation module 445 generates the lesson recommendation based on a health assessment completed by the user. The health assessment may include a questionnaire filled out through the web platform 105 by the user. The recommendation module 445 may use answers from the health assessment to determine which health lessons to recommend and/or schedule for the user (e.g. on the user calendar as described above). The health lessons may include content uploaded by a content provider and may comprise text, graphics, video, and/or other forms of presentation to instruct a user on various health topics. In one embodiment, the recommendation module 445 tracks a user's completion of each recommended lesson. In some embodiments, a user completes each recommended health lesson before the user meets with a content provider for a virtual appointment.

The user page module 450 provides one or more user pages for the user. The user pages may include web pages of the web platform associated with the user account allowing the user to navigate available web pages of the web portal 105 and access various health information. The user pages may be based on the user category of the user (e.g. a healthcare provider user's page may appear differently than a patient user's page) and may include visual representations of applications that the user has associated with the user's user account.

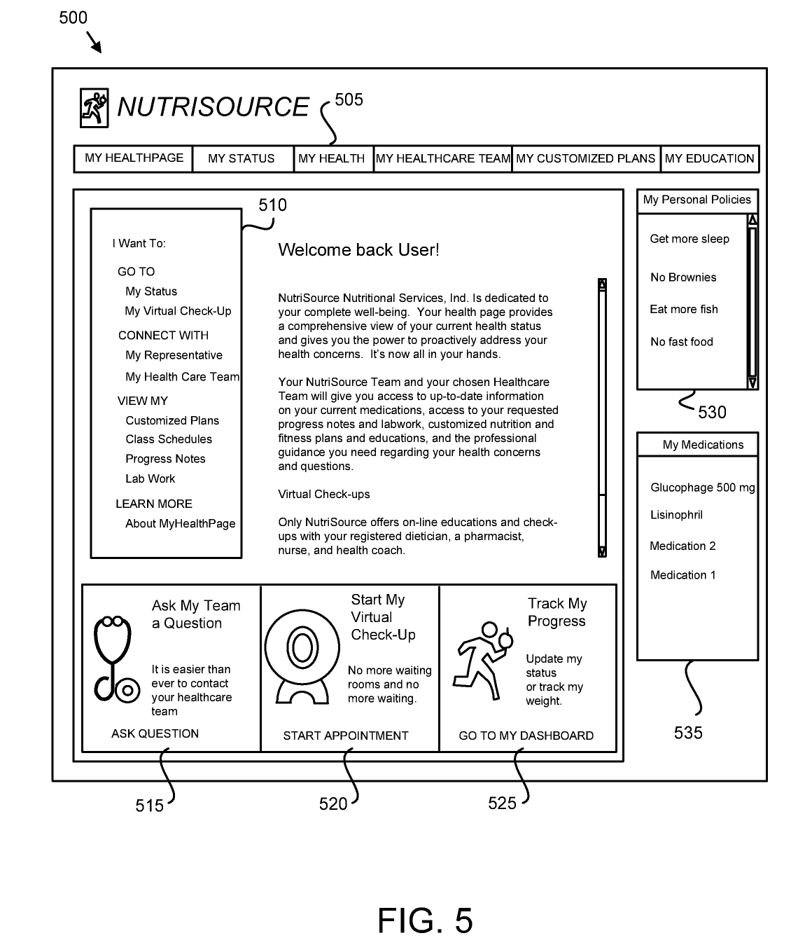

FIG. 5 illustrates one non-limiting example embodiment of a patient user page 500. The patient user page 500 includes links 505, 510 to various applications, health information documents, and content of the user. In the depicted embodiment, the patient user page includes a link 515 to send a message to the user's healthcare team, a link 520 for a virtual appointment, and a link 525 to additional health information for the user (e.g. a health status update). The patient user page may include more health information for the user such as medications 535 and goals 530. A patient user page may provide visual representations of other suitable information related to the web platform, the user account, content, and/or health information for the user.

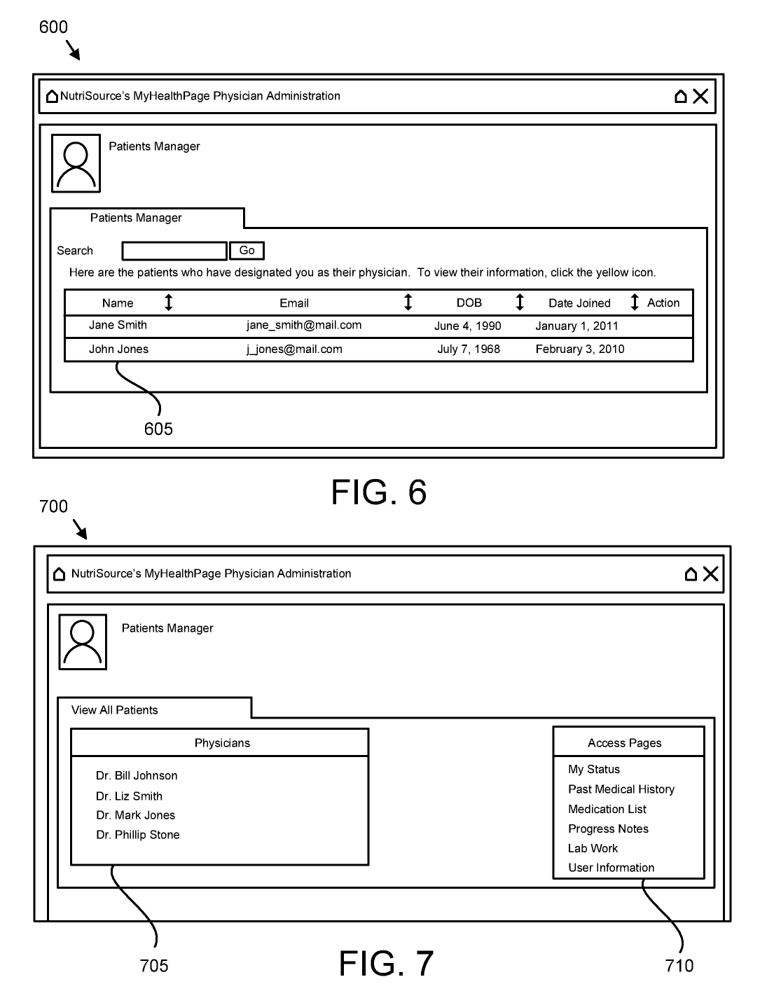

FIG. 6 illustrates one non-limiting example embodiment of a healthcare provider user page 600. The healthcare provider user page 600 may include a list 605 of patient users on whose healthcare team the healthcare provider belongs. FIG. 7 illustrates another non-limiting example embodiment of a healthcare provider user page 700, which may be displayed when the healthcare provider selects a particular patient user. The healthcare provider user page 700 may depict the other members 705 of the particular patient user's healthcare team and include links 710 to the particular patient user's health information documents and additional health information.

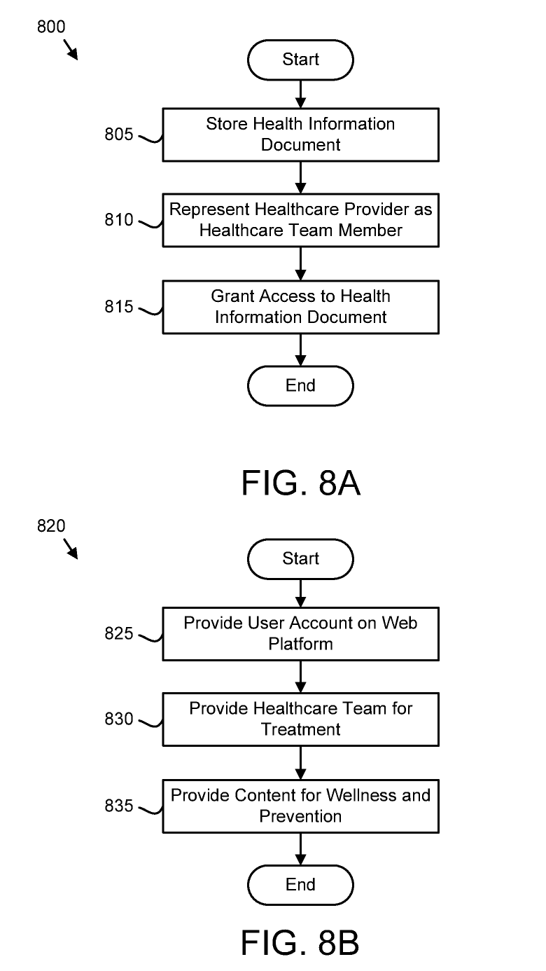

FIG. 8A depicts one embodiment of a method 800 for a healthcare and wellness platform. The method 800 may substantially include the steps to carry out at least a portion of the functions presented above with respect to the operation of the described apparatus and system of FIGS. 1-3. The description of the method 800 refers to elements of FIGS. 1-3, like numbers referring to like elements.

The method 800 begins and the health information module 305 stores 805 a health information document for a user on a web platform 105 in response to a health information request from the user. The stored health information document may be controllable by the user. Next, the healthcare team module 310 represents 810 a plurality of healthcare providers as members of a healthcare team on the web platform 105. The healthcare team may be specific to the user. The access module 315 grants 815 access to the health information document to the plurality of members of the healthcare team according to user configurable criteria. Then, the method 800 ends.

FIG. 8B depicts another embodiment of a method 820 for a healthcare and wellness platform. The method 820 may substantially include the steps to carry out at least a portion of the functions presented above with respect to the operation of the described apparatus and system of FIGS. 1-4. The description of the method 820 refers to elements of FIGS. 1-3, like numbers referring to like elements.

The method 820 begins and the user account module provides 825 a user with access to a user account on the web platform 105. The user account may aggregate the user's official health records with user-generated health information. Next, the healthcare team module 310 provides 830 a healthcare team for the user to aid in treatment of injury and/or disease. The content provider module 420 provides 835 content from one or more wellness and prevention entities to help the user maintain a healthy lifestyle. This content may be more suited to a user's day to day living that advice and/or treatment from members of the healthcare team. Then, the method 820 ends.

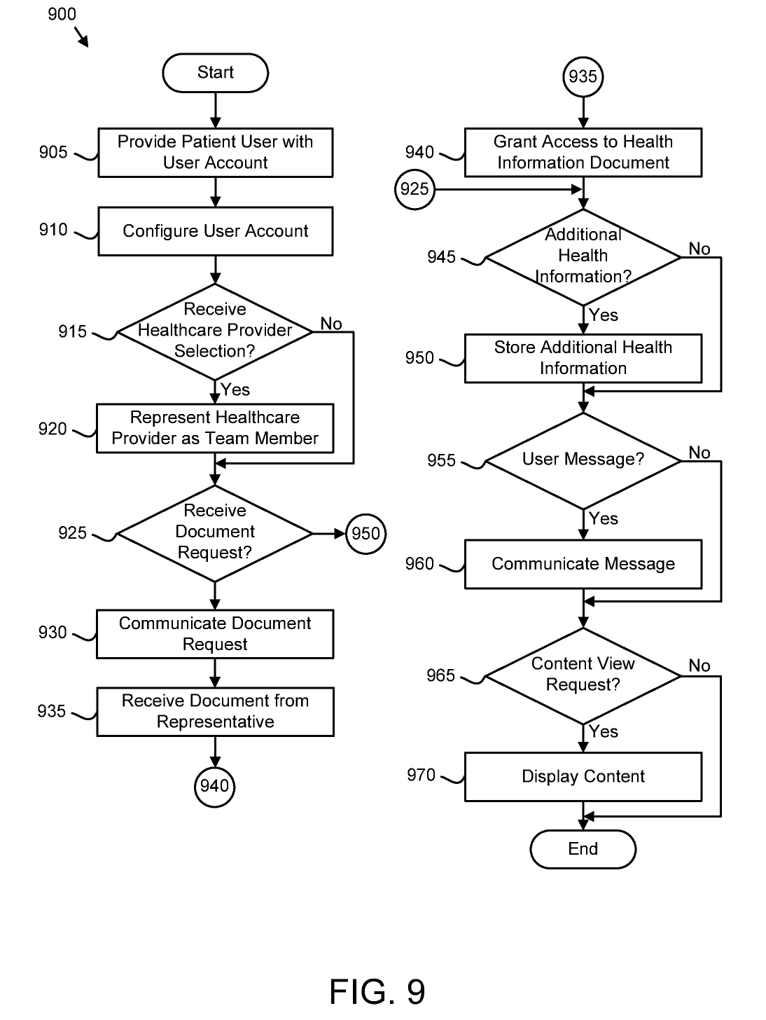

FIG. 9 depicts another embodiment of a method 900 for a healthcare and wellness platform. The method 900 may substantially include the steps to carry out at least a portion of the functions presented above with respect to the operation of the described apparatus and system of FIGS. 1-4. The description of the method 900 refers to elements of FIGS. 1-4, like numbers referring to like elements.

The method 900 begins and the user account module 410 provides 905 a patient user with a user account on the web platform 105. The application configuration module 415 allows the user to configure 910 the user account. If the healthcare team module 310 receives 915 a user selection of a particular healthcare provider for the healthcare team, the healthcare team module 310 represents 920 the particular healthcare provider as a member of the user's healthcare team.

Next, if the health information module 305 receives 925 a health information request from the user for a health information document, the representative module 430 communicates 930 the health information request from the user to a representative user instructing the representative user to obtain the health information document. The health information module 305 then receives 935 the document from the representative. Next, the access module 315 grants 940 access to the health information document to members of the user's healthcare team according to user configurable criteria.

Next, if the health information module 305 receives 945 additional health information from the user, the health information module 305 stores 950 the additional health information from the user. Next, if the communication module 435 detects 955 a message from the user, the communication module 435 communicates 960 the message between the user and the intended recipient such as a healthcare team member, a healthcare provider user, a content provider user and/or a representative user.

Next, if the user page module 450 detects 965 the user requesting to view content, the user page module 450 displays 970 the content. The content may include static content or customized content from a content provider. Then, the method 900 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
storing a health information document of a user on a web platform in response to a health information request, the stored health information document controllable by the user;
representing a plurality of healthcare providers as members of a healthcare team on the web platform, the healthcare team specific to the user; and
granting access to the health information document to the plurality of members of the healthcare team according to configurable criteria.

2. The method of claim 1, further comprising displaying content from a content provider, the content provider comprising a wellness and prevention entity, the content provider different from the plurality of healthcare providers.

3. The method of claim 2, further comprising managing the content from the content provider, wherein managing content further comprises:
receiving commands from the content provider to one or more of store, delete, and edit the content for one or more users; and
one or more of storing, deleting, and editing the content in response to receiving the commands.

4. The method of claim 3, wherein the content comprises one or more of wellness and prevention content and wherein the content further comprises one of customized content and static content, the customized content comprising one or more of a menu, a health goal, a shopping list, an education plan, an activity plan, an exercise plan, the static content comprising one or more of a health guide, an educational video, and a health lesson.

5. The method of claim 4, wherein the wellness and prevention entity comprises a dietician.

6. The method of claim 1, further comprising providing a plurality of user categories of users on the web platform, the user categories comprising a patient user category, a healthcare provider user category, and a content provider user category, the user comprising a patient user and the healthcare providers each comprising a healthcare provider user.

7. The method of claim 6, wherein the user categories further comprise a representative user category, the method further comprising communicating the health information request from the user to a representative user instructing the representative user to obtain the health information document.

8. The method of claim 1, further comprising providing a virtual appointment between the user and one or more of a content provider and a particular healthcare team member.

9. The method of claim 1, further comprising providing the user with a user account on the web platform, the user account associated with a plurality of applications on the web platform, the user account based on a user category of the user.

10. The method of claim 9, wherein one or more of the applications are configurable by the user, the method further comprising adding a first application to the user account in response to a user selection of the first application and removing a second application from the user account in response to a user removal of the second application.

11. The method of claim 1, further comprising storing additional health information from the user, the additional health information comprising one or more of health goals, a health status, calendar information, and medication information.

12. The method of claim 1, wherein at least two of the plurality of members are associated with one or more of different healthcare sources, different healthcare professions, and different healthcare fields.

13. The method of claim 1, further comprising generating a lesson recommendation for the user, the lesson recommendation recommending one or more health lessons for participation by the user over the web platform.

14. An apparatus comprising:
a health information module configured to store a health information document of a user on a web platform in response to a health information request, the stored health information document controllable by the user;
a healthcare team module configured to represent a plurality of healthcare providers as members of a healthcare team on the web platform, the healthcare team specific to the user; and
an access module configured to grant access to the health information document to the plurality of members of the healthcare team according to user configurable criteria.

15. The apparatus of claim 14, further comprising a content provider module configured to display content from a content provider, the content provider comprising a wellness and prevention entity, the content provider different from the plurality of healthcare providers.

16. The apparatus of claim 15, wherein the content provider module is further configured to manage content from a content provider, wherein the content provider module managing content further comprises the content provider module receiving commands from the content provider to one or more of store, delete, and edit the content for one or more users, the content provider module one or more of storing, deleting, and editing the content in response to receiving the commands.

17. The apparatus of claim 16, wherein the content comprises one or more of wellness and prevention content and wherein the content further comprises one of customized content and static content, the customized content comprising one or more of a menu, a health goal, a shopping list, an education plan, an activity plan, an exercise plan, the static content comprising one or more of a health guide, an educational video, and a health lesson.

18. The apparatus of claim 17, wherein the wellness and prevention entity comprises a dietician.

19. A computer program product comprising a computer readable storage medium having computer readable program code embodied therewith, the computer readable program code for:
storing a health information document of a patient on a web platform in response to a health information request, the stored health information document controllable by the patient;
representing a plurality of healthcare providers as members of a healthcare team on the web platform, the healthcare team specific to the patient; and
granting access to the health information document to the plurality of members of the healthcare team according to configurable criteria.

20. The computer program product of claim 19, further comprising displaying content from a content provider, the content provider comprising a wellness and prevention entity, the content provider different from the plurality of healthcare providers.
